(19) United States
(12) Patent Application Publication
(10) Pub. No.: US 2026/0347012 A1
(43) Pub. Date: Nov. 5, 2026

(54) IMPULSE PROPULSION SYSTEM WITH PROPELLER ARRANGED INSIDE LONGITUDINAL TUBE TO TRANSFORM TRANSLATIONAL MOVEMENT OF PROJECTILE INTO ROTATIONAL MOVEMENT

(71) Applicant: WARPA (WORLD ADVANCE RESEARCH PROJECT AGENCY), TOULOUSE (FR)

(72) Inventor: Jean-François GENESTE, TOULOUSE (FR)

(21) Appl. No.: 19/705,753

(22) Filed: Jun. 11, 2026

Related U.S. Application Data
(63) Continuation-in-part of application No. 18/725,137, filed on Dec. 27, 2022, now abandoned.

(30) Foreign Application Priority Data
Dec. 28, 2021 (FR) 2114570

(51) Int. Cl. B64G 1/40; B64G 1/58

(52) U.S. Cl. CPC B64G 1/40; B64G 1/58

(57) ABSTRACT

A space propulsion system includes a motor having a pair of parallel longitudinal tubes. Each longitudinal tube includes a first end and a second end, and delimits an internal volume filled with the fluid. Each longitudinal tube includes a projectile, configured to move longitudinally in the internal volume, fixedly secured to a propeller. Each longitudinal tube includes a mechanism to launch the projectile in the internal volume, from the first end. The propeller is arranged so as to transform a translational movement of the projectile into a rotational movement. Each longitudinal tube includes a device to slow the rotation of the projectile in the internal volume, arranged at the second end, a device to return the projectile toward the first end, and a heat dissipation device. The propellers of the longitudinal tubes are contrarotating.

### RELATED APPLICATIONS

This application is continuation-in-part application of application Ser. No. 18/725,137 filed Jun. 28, 2024, which is a § 371 application of PCT/FR2022/052510 filed Dec. 27, 2022, which claims priority from French Patent Application No. 2114570 filed Dec. 28, 2021, each of which is incorporated herein by reference in its entirety

### TECHNICAL FIELD OF THE INVENTION

The invention relates to a propulsion system, and more specifically to an impulse propulsion system in which initial projectile translation is converted directly into propeller rotation with momentum loss resulting in a remaining global translation motion of the propulsion system. In particular, the invention is intended for application in the space field, to equip a spacecraft such as a satellite.

### BACKGROUND OF THE INVENTION

To date, space propulsion is based on the action and reaction principle. In a schematic manner, it is reflected, in terms of propulsion, by the conservation of momentum in an isolated system. Typically, if gases are ejected from a spacecraft with a given momentum, a momentum with the same modulus and an opposite direction to that of the gases is transmitted to said spacecraft. In such a case, it is necessary to consume material to advance, since momentum should be ejected out of the spacecraft. The efficiency of a propulsion system is measured by a quantity called specific impulse, whose unit is the second. However, this quantity does not represent everything. Indeed, currently, to place a six-ton telecommunications satellite from a geostationary transfer orbit (also so-called “GTO” orbit) into a geostationary orbit (also so-called “GEO” orbit), with a chemical propulsion wherein the specific impulse of the motor lasts 320 seconds, eight days are necessary and three tons of fuel are on-board said satellite. With an electric propulsion wherein the specific impulse of the motor is 1,500 seconds, eight months are necessary but only 400 kg of fuel (generally xenon) are on-board, bringing the mass of the satellite to less than four tons.

Conventional propulsion systems typically rely on rotating shafts, geartrains, and combustion or electromagnetic rotary drives. Propulsion mechanisms such as turbines, propellers, electric motors, and crankshaft systems generally require complex transmission components to convert between linear and rotational motion.

Projectile launch systems, such as coil guns or pneumatic launchers, have been primarily used for acceleration of free projectiles, not for sustained cyclic propulsion. These systems lack a mechanism to recapture projectile motion, return the projectile to a starting position, or convert projectile translation into useful rotary output in a closed-loop operation.

In other words, current electric propulsion systems have a high specific impulse, but a low thrust, which results in very long mission's times and lower launch costs, because the mass of the fuel, for a given mission, is much lower than with chemical propulsion systems.

Moreover, once a satellite, whatever it is, is in position, its orbit describes a plane. A plane change cannot currently be considered because of excessive fuel consumption.

On the other hand, a satellite in a polar orbit, therefore travelling, generally has a service life of five years, which corresponds to the time necessary to consume the on-board fuel.

Finally, space debris is becoming more numerous, the number of avoidance maneuvers increases and, consequently, the service life of the satellites in low orbit potentially decreases.

### OBJECT AND SUMMARY OF THE INVENTION

The present invention aims to overcome the aforementioned drawbacks. That is, there is a need for a propulsion architecture that conveys very high specific impulse. The proposed principle here is, from a high translational specific impulse, to deem it through rotation induction of the projectile, implying local losses which, after a cascade of shocks, will not transfer the counter momentum completely to the hosting structure.

To this end, the present invention provides a propulsion system comprising a motor comprising a pair of parallel longitudinal tubes. Each longitudinal tube comprises a first end and a second end, and defining an internal sealed volume filled with a working fluid. Each longitudinal tube comprises:
a projectile, configured to move longitudinally in the internal volume, and fixedly secured or rigidly coupled to a propeller such that the translational movement of the projectile directly induces rotation of the propeller,
a projectile launcher to launch the projectile in the internal volume, from the first end of the longitudinal tube, the propeller being arranged so as to transform a translational movement of the projectile into a rotational movement,
a brake to retard, slow or break the rotation of the projectile in the internal volume, positioned at the second end of the longitudinal tube,
a projectile return mechanism to return the projectile from the second end towards the first end of the longitudinal tube, and
a heat dissipator.

The projectile launcher and the projectile return mechanism are powered by at least one power source.

Each longitudinal tube comprises, in its internal volume, a projectile and a propeller rigidly coupled or fixedly secured to the projectile. The term “fixedly secured” herein means that there is no degree of freedom between the projectile and the propeller.

The propellers of the projectiles located in the two longitudinal tubes are contrarotating. Thus, when the propellers rotate, two identical, but opposite, kinetic moments will be created and will substantially cancel out.

Such a propulsion system is an impulse thrust propulsion system. At each launch of the projectile in its longitudinal tube by the projectile launcher, a momentum towards the second end of the longitudinal tube is imparted on the projectile. During the impulse, a momentum in the opposite direction is imparted on the longitudinal tubes, and therefore on the propulsion system, in accordance with the above-described action and reaction principle.

In accordance with an exemplary embodiment, the projectile launcher located at the first end accelerates the projectile longitudinally within the internal sealed volume filled with a working fluid. The working fluid forces the propeller to rotate as the projectile advances. The rotational brake at the second end decelerates and stops the rotation of the projectile. During the translation motion of the propeller, the fluid will both make the propeller rotate and slow down. The projectile return mechanism subsequently returns the projectile to the initial launch position, i.e., the first end, completing a propulsion cycle. The heat-dissipator removes the thermal energy, i.e., the heat, resulting from the repeated cycles. The propellers in the pair of parallel longitudinal tubes rotate in the opposite directions, creating a contrarotation propulsion output that minimizes net rotational torque on the system or the spacecraft utilizing the claimed propulsion system.

Advantageously, the propulsion system according to the claimed invention allows converting the translational movement of the projectile, in part, into a rotational movement, thanks to the viscosity of the working fluid. A portion of the rotational movement will be transformed into heat, due to the viscosity of the working fluid, and another portion will be transformed, depending on the nature of the braking device, either into heat, or into electrical energy. Thus, the portion transformed into rotation is expected to intervene in the equilibrium of the total longitudinal momentum of the system.

At a given time point, the projectile has a non-zero translational speed towards the second end. Hence, it will encounter fluid molecules, and the propeller will transform a portion of the translational energy into rotational energy of the projectile. At the end of travel, at the second end of the longitudinal tube, the projectile potentially no longer has any translational speed, but has a rotational speed. If the principle of conservation of momentum is applied, the angular momentum should also be conserved. Yet, it is the working fluid contained in the internal volume of the longitudinal tube, and not the longitudinal tube itself, which sets the propeller and the projectile into motion. Hence, there is a system with a conservation of translational momentum, i.e., non-movable, but with a non-zero angular moment. Hence, the principle of conservation of momentum in an isolated system does not apply to the claimed invention, since the claimed system is not isolated.

However, the first thought is to think that the claimed device is operating as an isolated system in space and therefore that the theorem of conservation of momentum is applicable and hence it cannot work. The basic reason why such reasoning is incorrect is because the claimed system itself is made of non-isolated parts in which there is dissipation. This completely makes the claimed system out of the conditions for application of the theorem of the conservation of momentum, as detailed herein.

In addition, in each longitudinal tube, the heat created during the travel of the projectile in the internal volume is evacuated by the heat dissipator. Hence, the use of a heat dissipator proves that the propulsion system does not function like an isolated system.

The longitudinal tubes (volume, length), the mass of the projectile and the impulse imparted on the projectile are sized so that, in each longitudinal tube, the translational movement of the projectile stops at the second end of the longitudinal tube.

Advantageously, the projectile return mechanism allows the returning of the projectile from the second end to the first end of the longitudinal tube in order to be launched again.

Advantageously, the propulsion system according to the claimed invention is a propulsion system with a completely passive and dissipative reaction mass, wherein each projectile and its propeller serve as a reaction mass and are configured to move freely and passively in the internal volume of the longitudinal tube in which they are arranged. The propeller is arranged to transform a translational movement of the projectile into a rotational movement, via a passive and dissipative interaction with the working fluid contained in the internal volume of the longitudinal tube containing the propeller.

In accordance with an exemplary embodiment, the claimed invention further meets the following characteristics, implemented separately or in each of the technically operative combinations thereof.

In accordance with an exemplary embodiment of the claimed invention, to avoid contact between the projectile and the longitudinal tube, each longitudinal tube comprises a projectile holder to hold the projectile in the internal volume.

In accordance with an exemplary embodiment of the claimed invention, the projectile holder comprises at least one connecting arm extending between the projectile and the longitudinal tube.

In accordance with an exemplary embodiment of the claimed invention, in order not to hinder the rotation of the projectile during travel thereof in the longitudinal tube, the projectile holder and the projectile are connected by a pivot connection.

In accordance with an exemplary embodiment of the claimed invention, to direct the projectile, each longitudinal tube comprises a translational guide to guide the projectile in translation in the internal volume.

In accordance with an exemplary embodiment of the claimed invention, the translational guide cooperates with the projectile holder.

In accordance with an exemplary embodiment of the claimed invention, the same power source is configured to power the projectile launcher and the projectile return mechanism of each longitudinal tube.

In accordance with an exemplary embodiment of the claimed invention, the propulsion system comprises a tilter configured to independently pivot each of the two longitudinal tubes about a parallel respective pivot axis, preferably by about 90°, in opposite directions. The tilter is activated only once the projectile has reached the second end of the longitudinal tube, to accelerate the return of the projectile, by the projectile return mechanism, towards the first end of the longitudinal tube.

In accordance with an exemplary embodiment of the claimed invention, to increase the thrust of the propulsion system in the same direction, the propulsion system comprises a plurality of pairs of parallel longitudinal tubes, the pairs being arranged parallel to one another.

The claimed invention also relates to a vehicle, in particular a spacecraft, comprising a propulsion system in accordance with exemplary embodiments of the claimed invention. A spacecraft equipped with the claimed propulsion system would have its travel time reduced for a given orbit, in comparison with a spacecraft equipped with conventional chemical or electrical propulsion systems, with no fuel consumption.

### BRIEF DESCRIPTION OF THE FIGURES

The invention will be better understood upon reading the following description, given merely as non-limiting example, and made with reference to the figures:

FIG. 1 illustrates a propulsion system comprising a motor comprising a pair of longitudinal tubes, according to an exemplary embodiment of the claimed invention,

FIG. 2 illustrates a variant embodiment of a projectile in a longitudinal tube,

FIG. 3 illustrates a propulsion system comprising a motor comprising a pair of longitudinal tubes, according to an exemplary embodiment of the claimed invention,

FIG. 4 illustrates a spacecraft comprising the propulsion system comprising a plurality of pairs of parallel longitudinal tubes according to an exemplary embodiment of the claimed invention,

FIG. 5 illustrates an exemplary physical model of an astronaut with a vertical cylinder with two blades,

FIG. 6 illustrates an exemplary National Advisory committee for Aeronautics (NACA) profile,

FIG. 7 illustrates a ping-pong ball in a vacuum tube,

FIG. 8 illustrates an exemplary fluid solid collision,

FIG. 9 illustrates an exemplary modeling of the fluid molecule, and

FIG. 10 illustrates an exemplary time section of the collision between the solid and the fluid molecule.

In these figures, for clarity, the drawings are not plotted to scale, unless stated otherwise.

### DETAILED DESCRIPTION OF THE EMBODIMENTS

The present invention relates to a propulsion system.

In general, this propulsion system could equip any transport means, in particular those of the aeronautical, space, railway, automotive or maritime fields, without restricting the claimed invention.

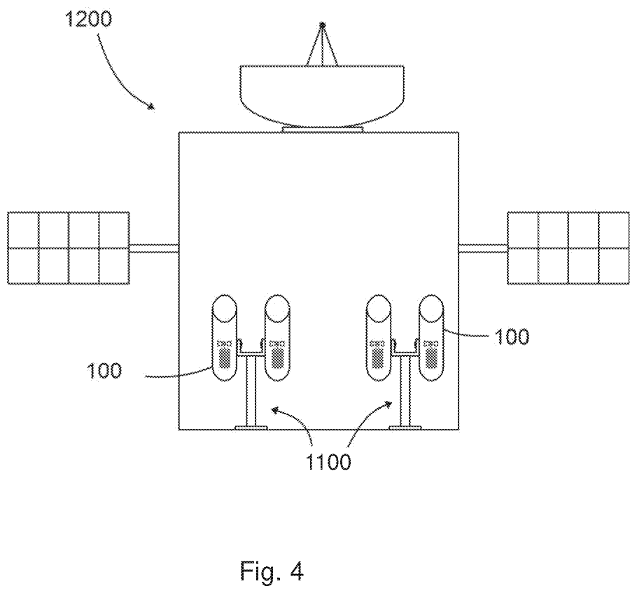

The claimed invention is described in the particular context of one of its preferred fields of application in which the propulsion system is configured to be installed in a spacecraft 1200, such as a satellite 1200, shown in FIG. 4. However, nothing excludes the possibility of arranging the propulsion system in any other vehicle type.

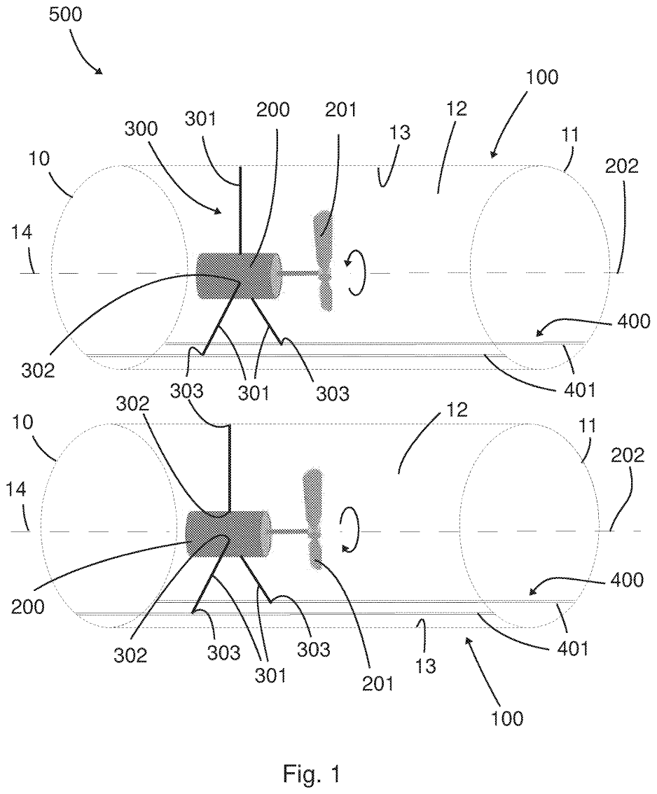

FIG. 1 schematically illustrates a propulsion system according to an exemplary embodiment of the claimed invention.

The propulsion system comprises a motor 500. The motor 500 comprises at least one pair of longitudinal tubes 100.

In the remainder of the description, the propulsion system will be described in the preferred case where the motor 500 comprises a pair of longitudinal tubes, as illustrated in FIG. 1, but the claimed invention is not limited to such configuration.

Advantageously, the two longitudinal tubes 100 are arranged parallel to one another.

Preferably, the two longitudinal tubes 100 are similar and independent of one another.

Each longitudinal tube 100 comprises two longitudinal ends, the first end 10 and the second end 11. Each longitudinal tube 100 is hermetically closed, sealed and closed at both longitudinal ends thereof.

Advantageously, the two longitudinal tubes 100 are positioned in the same direction, with their first ends 11 arranged on the same side.

In the example of FIG. 1, the first ends 11 of the longitudinal tubes 100 are located to the left in FIG. 1.

Preferably, each longitudinal tube 100 has a circular cross-section, as illustrated in FIG. 1, but may also have any other cross-sectional shape, for example square, rectangular, elliptical, etc., without limiting the claimed invention.

Preferably, each longitudinal tube 100 is made of a carbon material.

Each longitudinal tube 100 delimits a hollow internal sealed volume 12 in which the working fluid evolves.

Preferably, the working fluid is a viscous fluid.

In a preferred embodiment, the working fluid is a gas, such as air.

In other embodiments, the working fluid may be Newtonian fluid or a non-Newtonian fluid. A fluid is called Newtonian when it does not modify its behavior under the effect of mechanical stresses.

In accordance with an exemplary embodiment of the claimed invention, the working fluid may be a fluid whose viscosity changes under the action of a magnetic or electrical field. These fluids are called magnetorheological fluid or electrorheological fluid, respectively.

Each longitudinal tube 100 comprises a projectile 200 in its internal volume 12. The projectile is intended and configured to move longitudinally in the longitudinal tube 100. In accordance with an exemplary embodiment, the projectile 200 is constrained to move solely in the longitudinal direction.

Preferably, the projectiles 200 of each longitudinal tube 100 are identical.

In accordance with an exemplary embodiment of the claimed invention, as illustrated in FIG. 1, each projectile 200 is, for example, in the form of a closed, hollow or solid cylinder. For example, each projectile 200 has a circular, square, rectangular, elliptical, etc., cross-section, without limiting the claimed invention. The projectile has length much smaller than the length of the longitudinal tube. In accordance with an exemplary embodiment of the claimed invention, the projectile 200 may include sealing rings, low-friction surfaces or hydrodynamic shapes to reduce drag.

In accordance with an exemplary embodiment of the claimed invention, as illustrated in FIG. 1, the longitudinal tube 100 and its projectile 200 have the same cross-section.

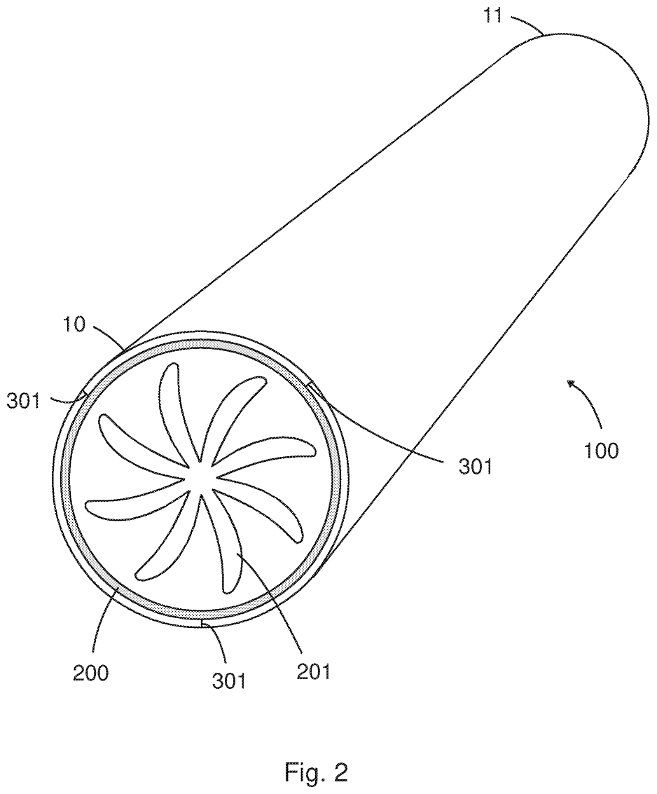

In accordance with an exemplary embodiment of the claimed invention, as illustrated in FIG. 2, when the longitudinal tubes 100 have a circular cross-section, each projectile 200 is in the form of an annular, hollow cylinder open at its ends, the wall of which is located proximate to the inner face 13 of the longitudinal tube 100. Thus, the mass of the projectile 100 is distributed close to the periphery of the longitudinal tube 100.

Advantageously, each projectile 200 is fixedly secured or rigidly coupled to a propeller 201.

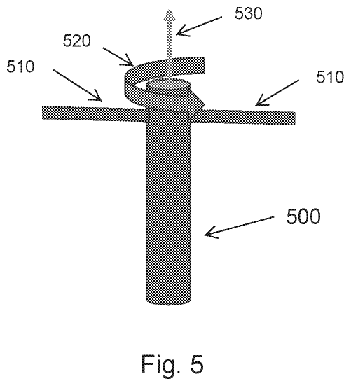

The term “fixedly secured” is understood to mean that there is no degree of freedom between the projectile 200 and the propeller 201. In other words, when the propeller 201 rotates, it drives the projectile in rotation, as exemplary shown in FIG. 5. When it rotates on itself, the propeller 201 drives the projectile in rotation on itself.

In accordance with an exemplary embodiment, the projectile 200 and the propeller 201 form an integrated assembly with no degree of freedom between them. Blade geometries, including helical or variable-pitch blades, may be selected to optimize conversion of linear motion into rotation.

A projectile 200 and its propeller 201 are both arranged in the internal volume 12 of a longitudinal tube. Hence, there are as many propellers as projectiles, and as longitudinal tubes.

Each projectile 200 and its propeller 201 are arranged in a longitudinal tube 100 such that an axis of rotation 202 of the propeller, and consequently an axis of rotation of the projectile, is parallel to or coincident with an axis of revolution 14 of said longitudinal tube 100. Preferably, the axis of rotation 202 of the propeller is coincident with the axis of revolution 14 of the longitudinal tube 100, as illustrated in FIG. 1.

In accordance with an exemplary embodiment of the claimed invention, as illustrated in FIG. 1, the propellers 201 of the projectiles 200 are located at one end of the projectile, on the same side, in their respective longitudinal tubes 100.

Preferably, as illustrated in FIG. 1, in each longitudinal tube 100, the projectile 200 faces the first end 10 of said longitudinal tube 100 and the propeller 201 faces the second end 11 of the longitudinal tube 100.

In accordance with an exemplary embodiment of the claimed invention, as illustrated in FIG. 2, the propellers 201 of the projectiles are located inside the cylinder forming the projectiles, in their respective longitudinal tubes 100. Thus, the projectiles 100 disturb the flow less.

Advantageously, the propellers 201 of the projectiles 200 located in the longitudinal tubes 100 of the pair of longitudinal tubes are contrarotating, i.e., they rotate in opposite directions. Propellers 201 are mirrored so that one rotates clockwise and the other counterclockwise during projectile travel. Thus, when the propellers 201 rotate, two identical, but opposite, kinetic moments will be created simultaneously, the sum of which is approximately zero. That is, the contrarotating pair of longitudinal tubes produces a torque-balanced propulsion. Thus, a spacecraft 1200 that would be equipped with a propulsion system with an even number of longitudinal tubes 100 and the arrangement of the propellers as described will not be unbalanced during the thrust.

The efficiency of propeller 201, i.e., its ability to transform the translational movement of the projectile 200 into a rotational movement, depends on the working fluid contained in the longitudinal tube and on the pressure in the internal volume of the longitudinal tube. In accordance with an embodiment, each longitudinal tube comprises a low-friction lining configured to reduce the projectile solid drag and increase conversion efficiency between translational and rotational motion.

In non-limiting embodiments of the claimed invention, a propeller 201 may be a propeller such as the aircraft propeller type, of the low-pressure compressor propeller type of aircraft turbojet engines, of the centrifugal compressor propeller type.

In accordance with an exemplary embodiment of the claimed invention, the propeller is a variable-pitch propeller. Preferably, an electronic, or mechanical, device is configured to adjust the pitch, in particular by modifying the pitch angle of the blades of the propeller.

Preferably, each longitudinal tube 100 comprises a projectile holder 300 to hold the projectile in the internal volume 12 of the longitudinal tube. Advantageously, the projectile holder 300 allows preserving the positioning of the projectile 200 at a distance from the inner face 13 of the longitudinal tube 100, so that the projectile 200, and/or its propeller 201, touches the inner face during the operation of the motor 500.

Preferably, the projectile holder 300 is identical for both tubes of the pair of longitudinal tubes 100.

In accordance with an exemplary embodiment of the claimed invention, the projectile holder 300 comprises at least one connecting arm 301, preferably a plurality of connecting arms 301. Each connecting arm 301 is rigid and extends between the projectile 200 and the longitudinal tube 100. Each connecting arm 301 comprises a first end 302 arranged on the projectile 200 side and a second end 303 arranged on the longitudinal tube 100 side.

Preferably, the projectile holder 300 comprises the plurality of connecting arms 301 and the connecting arms 301 are arranged in the same plane.

In the non-limiting embodiment of the claimed invention, as described in FIG. 1, the projectile holder 300 comprises three connecting arms 301 arranged at 120° with respect to one another. Such number and arrangement of the connecting arms is particularly suitable when the longitudinal tube has a circular cross-section, for example.

In accordance with an exemplary embodiment of the claimed invention, not shown in the figures, the projectile holder 300 comprises four connecting arms arranged at 90° with respect to one another. Such number and arrangement of the connecting arms is particularly suitable when the longitudinal tube has a square or rectangular cross-section, for example.

Preferably, the projectile holder 300 is connected to the projectile 200 such that it does not prevent the rotation of the projectile 200 about its axis of rotation. In other words, the projectile holder 300 and the projectile 200 are connected by a connection with one single degree of freedom. This single degree of freedom is a rotational degree of freedom, enabling the rotation of the projectile about its axis of rotation. The connection is a pivot connection.

In accordance with an exemplary embodiment of the claimed invention, the projectile holder 300 is connected to the projectile 200 via at least one bearing (not shown).

In accordance with an exemplary embodiment of the claimed invention, the projectile holder 300 comprises a plurality of connecting arms 301 arranged in the same plane and each first end 302 of a connecting arm is connected to the projectile 200 via one single bearing.

Preferably, each longitudinal tube 100 comprises a translational guide 400 to guide the projectile in translation. Advantageously, such a translational guide 400 allows guaranteeing the movement of the projectile 200 longitudinally in the longitudinal tube 100 between the two longitudinal ends 10, 11. Advantageously, the translational guide 400 cooperates with the projectile holder 300.

Preferably, the translational guide 400 is identical for both tubes of the pair of longitudinal tubes 100.

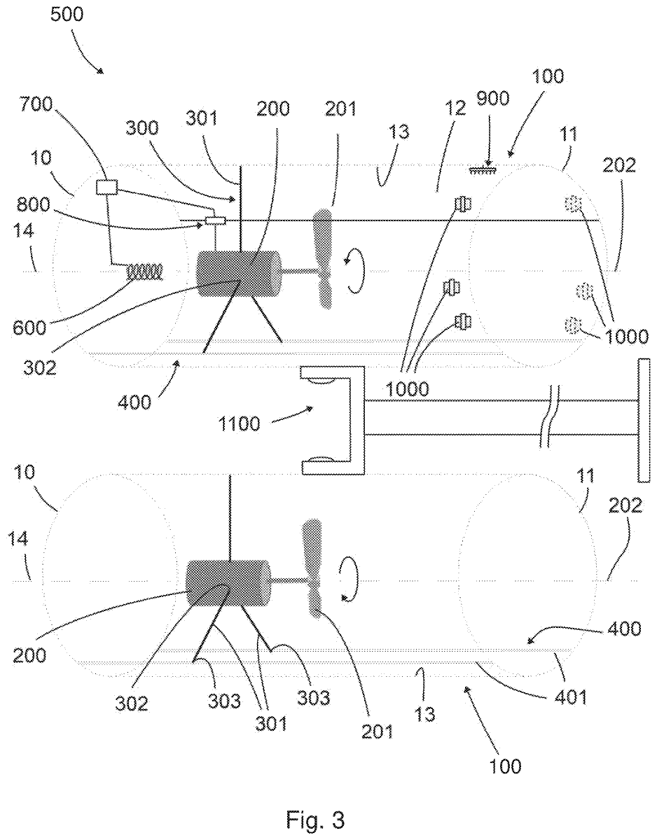

In accordance with an exemplary embodiment of the claimed invention, as illustrated in FIGS. 1 and 3, the translational guide 400 comprises at least one longitudinal groove 401, formed in the longitudinal tube 100, from the inner face 13.

Preferably, the longitudinal tube 100 comprises as many longitudinal grooves 401 as connecting arms 301. The second end 303 of each connecting arm 301 is configured to slip, slide or roll in an associated longitudinal groove 401.

Each longitudinal tube 100 comprises a projectile launcher 600 to launch the projectile 200, as shown in FIG. 3. The projectile launcher 600 to launch the projectile 200 is configured to exert a thrust on the projectile 200 to set it in motion and to launch it in the longitudinal tube 100. In accordance with an exemplary embodiment, the projectile launcher 600 comprises an electromagnetic linear motor, a coil-gun accelerator, a solenoid array, a pneumatic actuator or a hydraulic pressure chamber. The projectile launcher 600 delivers a controlled impulse, accelerating the projectile 200 along the longitudinal tube 100.

Preferably, the projectile launcher 600 is arranged at the first end 10 of the longitudinal tube 100. Thus, the projectile 200 moves in the longitudinal tube 100 from the first end 10 towards the second end 20.

Preferably, the projectile launcher 600 is identical for both tubes of the pair of longitudinal tubes 100.

In accordance with an exemplary embodiment of the claimed invention, the projectile launcher 600 comprises an electromagnet.

In accordance with an exemplary embodiment of the claimed invention, the projectile launcher 600 is a catapult or compression spring type mechanical system.

In accordance with an exemplary embodiment of the claimed invention, the projectile launcher 600 is a compression spring, the projectile 200 is launched in the longitudinal tube 100 by the expansion of the compression spring 600 which has been compressed beforehand.

Preferably, at least one electric power source 700 shown in FIG. 3 is configured to activate the projectile launcher 600 in each longitudinal tube 100. Advantageously, the power source 700 is connected to the solar panels installed on the spacecraft 1200 or the batteries on-board spacecraft 1200.

Thus, at each longitudinal tube 100, the projectile launcher 600 is advantageously configured to impart a starting impulse on the projectile 200, at a predetermined speed. A momentum, or a kinetic energy, towards the second end 11 of the longitudinal tube 100 is then imparted on projectile 200. At the time of this impulse, an equal momentum, in the opposite direction, is imparted on the longitudinal tube 100. During the advance of the projectile 200 in the longitudinal tube 100, the blades of the propeller 201 will undergo a drag, which will slow or arrest the projectile 200, and a lift which will drive the propeller 201 and therefore the projectile 200, in rotation. Thanks to propeller 201, the translational movement of the projectile 200 in a longitudinal tube 100 will thus be progressively transformed into a rotational movement. This rotational movement of the projectile 200 will cause a progressive braking of the translational movement of the projectile 200 in the longitudinal tube 100, while creating heat.

Each blade of the propeller 201 will have a shape drag and a friction drag. The friction drag, related to the viscosity of the working fluid, will enable movement according to the well-known laws of fluid mechanics. In accordance with an exemplary embodiment of the claimed invention, the blades of the propeller 201 are designed and configured to maximize the friction drag. It is this friction which will generate heat, and, this heat being released to the outside, makes the system non-isolated, thereby a non-conservation of the overall momentum.

In accordance with an exemplary embodiment of the claimed invention, the propeller 201 is a variable-pitch propeller, the associated electronic or mechanical device is configured to adjust the pitch during the movement of the projectile in its longitudinal tube 100, allowing maximizing frictions.

In other words, at each longitudinal tube 100, the initial translational kinetic energy of the projectile 200 is partially transformed, on the one hand, into rotational kinetic energy and, on the other hand, into heat. It is this rotational kinetic energy portion, created “naturally,” which will be obtained, essentially, as an equivalent of the momentum transmitted to the spacecraft 1200 at the end of the process of movement of the projectile in the longitudinal tube 100.

The longitudinal tubes 100 are sized in length so that the translational movement of the projectile 200 stops proximately to the second end 11 of the longitudinal tube 100, the closest to the second end, without the projectile 200 or the propeller 201 of the projectile 200 touching the second end 11.

In particular, the length of a longitudinal tube 100 depends on the mass of the projectile 200, on the impulse imparted on the projectile 200 by the projectile launcher 600, on the efficiency of the propeller, in the fluid environment in which the projectile 200 is moving, and on the viscosity of the working fluid, which viscosity may depend on parameters such as the temperature or also on externally regulated parameters like an electromagnetic, electrical or magnetic field depending on the very nature of the fluid. The calculation of this length is within the reach of a person of ordinary skill in the art.

In accordance with an exemplary embodiment of the claimed invention, each longitudinal tube 100 may have a length in the range of 4 m and a diameter in the range of 50 cm, with a projectile mass in the range of one kilogram. The launch speed of the projectile 200 is in the range of 400 to 500 km/h.

As described herein, for each longitudinal tube 100, following the impulse imparted on the projectile 200, heat is created in the longitudinal tube 100 during the movement of the projectile 200, because of the frictions of the working fluid.

Advantageously, each longitudinal tube 100 comprises a heat dissipator or heat sink 900, shown in FIG. 3. Repeated projectile cycles generate heat from friction, electromagnetic interactions and fluid compression. Heat is removed from either the projectile 200, the working fluid or the tube structure. In accordance with an exemplary embodiment, the heat dissipator 900 is a fluid cooling loop, thermal pads, conduction plates, a thermal conduction interface or a phase-changing material configured to absorb heat generated by repeated projectile cycles.

Preferably, the heat dissipator 900 is identical for both tubes of the pair of longitudinal tubes 100.

In accordance with an exemplary embodiment of the claimed invention, the heat dissipator 900 is a fin-type radiator, as shown in FIG. 3.

In the preferred application where the propulsion system equips the spacecraft 1200, for each longitudinal tube 100, the associated heat dissipator 900 can exchange with the empty space only via a black body radiation. Hence, the heat dissipator 900 is advantageously configured to emit photons, these photons having a momentum.

Advantageously, the heat dissipator 900 of each longitudinal tube 100 is arranged so that the emission of the photons takes place in a direction promoting the increase in the momentum of the propulsion system, therefore of the spacecraft 1200.

Advantageously, the emission of photons guarantees that the propulsion system cannot therefore be considered as an isolated system.

As described before, for each longitudinal tube 100, after launching the projectile 200, the translational travel of the projectile 200 stops at the second end 11 of the longitudinal tube 100. At of this second end 11, the projectile 200 is only rotating and rotates on itself at a given speed.

Advantageously, each longitudinal tube 100 comprises a rotational brake 1000, to decelerate, retard, slow and/or stop the rotation of the projectile, shown in FIG. 3.

Preferably, the rotational brake 1000 is identical for both tubes of the pair of longitudinal tubes 100.

In accordance with an exemplary embodiment of the claimed invention, the rotational brake 1000 comprises an electromagnetic brake or a mechanical brake. In accordance with an aspect of the claimed invention, the rotational brake 1000 may include: a magnetic eddy-current brake, a fluid dynamic drag grid, a mechanical damper or an electromagnetic deceleration coil. Preferably, the captured energy may be converted into reusable electrical power.

Stopping or slowing the rotation of the projectile 200 in each longitudinal tube 100 will create an opposite rotational parasitic kinetic momentum. Yet, the motor 500 of the propulsion system comprising a pair of longitudinal tubes 100, inside which the projectiles 200 with their propellers 201 rotate in a contrarotating manner, braking, as a first approximation, will not have a consequence at the propulsion system and therefore at the spacecraft 1200, because the rotational kinetic moments will substantially cancel out.

As described herein, for each longitudinal tube 100, after launching the projectile 200, the translational travel of the projectile 200 stops at the second end 11 of the longitudinal tube 100 and then the rotation of the projectile 200 is slowed or braked.

Advantageously, each longitudinal tube 100 comprises a projectile return mechanism 800 to return the projectile 200, shown in FIG. 3, towards the first end 10 of the longitudinal tube 100.

Preferably, the projectile return mechanism 800 is identical for the two tubes of the pair of longitudinal tubes 100.

The projectile return mechanism 800 is configured to return the projectile 200 located at the second end 11 back to the first end 10 of the longitudinal tube 100 to be launched again, where necessary, via the projectile launcher 600.

Preferably, the projectile return mechanism is configured to return the projectile 200 to a constant speed, lower than the launch speed of the projectile 200 in the transverse tube. Advantageously, the return of the projectile 200 towards the first end 10 at a constant speed allows creating practically no parasitic momentum at the propulsion system, and therefore at spacecraft 1200.

In accordance with an exemplary embodiment of the claimed invention, the projectile return mechanism 800 comprises an electromagnet accelerator or a worm screw. The electromagnetic accelerator may comprise a linear motor, a high-tension spring, a solenoid array or a coil-gun inductor. The motion may be continuous or sequential depending on the propulsion cycle timing.

In accordance with an exemplary embodiment of the claimed invention, to accelerate the return of the projectile 200 towards the first end 10 of the longitudinal tube 100, the propulsion system comprise a tilter 1100, shown in FIGS. 3 and 4. The tilter 1100 is configured to make each of the two longitudinal tubes 100 pivot independently about a parallel respective pivot axis, by an angle in the range of 90°, but in the opposite direction. Afterwards, projectiles 200 of each longitudinal tube 100 are returned towards the first end 10 of the associated longitudinal tube 100, therefore in the opposite direction, with the associated projectile return mechanism 800 described herein. The return of each projectile 200 towards the first end 10 of the associated longitudinal tube 100 could be carried out more rapidly because, on the one hand, the created momentums cancel out and, on the other hand, the created momentums do not parasitize the momentum imparted on the projectile 200 in the axis of revolution of the longitudinal tube 100 during the impulse, and therefore the opposite momentum transmitted to the longitudinal tube 100, during the impulse, and consequently to the propulsion system.

Preferably, at least one electric power source 700 is configured to activate the projectile return mechanism 800 in each longitudinal tube.

The electric power source 700 is connected to the solar panels installed on the spacecraft 1200 or the batteries on-board spacecraft 1200.

In accordance with an exemplary embodiment of the claimed invention, a common electric power source 700 is configured to activate the projectile launcher 600 and to activate the projectile return mechanism 800 of each longitudinal tube 100.

Hence, the propulsion system according to the claimed invention, as described, is an impulse thrust propulsion system rather than a continuous thrust propulsion system.

At each launch of the projectiles 200 in the two longitudinal tubes 100, a momentum, equal, yet opposite, to the momentum imparted on the projectile, is imparted on the longitudinal tubes, and therefore on the propulsion system.

Preferably, to avoid an imbalance of the spacecraft 1200, the launches of the projectiles 200 in the two longitudinal tubes 100 are carried out in a synchronized manner.

Depending on the frequency of the impulses, i.e., depending on the launch frequency of the projectiles 200 in each longitudinal tube 100, will depend on the average thrust per unit time of the propulsion system.

In particular, the frequency of the impulses depends on the time spent by the projectile 200 in each longitudinal tube 100 to return, with the projectile return mechanism 800, from the second end 11 of the longitudinal tube 100 to the first end 10.

The thrust of the propulsion system, in the same direction, could also be increased by increasing the number of pairs of longitudinal tubes 100, each pair of longitudinal tubes being arranged parallel to one another, with all longitudinal tubes in the same direction, as exemplary shown in FIG. 4. In accordance with an exemplary embodiment, the pair of longitudinal tubes are housed within a common structural frame to maintain parallel alignment during operation.

In accordance with an exemplary embodiment of the claimed invention, not shown in the figures, to improve, in particular, the efficiency of the propellers 201, each longitudinal tube 100 comprises a device for modifying the fluid viscosity and/or a device for modifying the temperature of the fluid and/or a device for modifying the pressure of the fluid.

In accordance with an exemplary embodiment of the claimed invention, to produce thrusts in all directions, at least one pair of longitudinal tubes 100 is mounted on a multi-axis system configured to orient at least one pair of longitudinal tubes in one direction, opposite to the desired thrust direction.

In accordance with an exemplary embodiment of the claimed invention, the brake 1000 to retard, slow or brake the rotation of the projectile 200 in the longitudinal tubes creates parasitic kinetic moments. The spacecraft 1200 comprising the propulsion system comprises inertia wheels configured to create an on-board kinetic momentum intended to balance the spacecraft 1200.

In a propulsion system comprising a predetermined number of pairs of longitudinal tubes 100 arranged parallel to one another, the propulsion system could therefore be configured in two ways:
a) all projectiles 200 of all pairs of longitudinal tubes 100 are launched in a synchronized manner: in this case, the thrust will be increased. In particular, the frequency of the impulses depends on the time spent by the projectile 200 in each longitudinal tube 100 to move from the first end 10 to the second end 11 of the longitudinal tube 100, and to return, with the projectile return mechanism 800, from the second end 11 to the first end 10 of the longitudinal tube 100, or
b) the projectiles 200 of each pair of longitudinal tubes 100 are launched successively: in this case, the thrust will be lower than if all projectiles 200 of all pairs of longitudinal tubes 100 are launched in a synchronized manner, but the frequency of the impulses will be increased.

The selected configuration may depend on the vehicle in which the propulsion system will be used, and on, in particular, the maneuvers carried out by the vehicle.

In the case of the use of the propulsion system in a preferred application in the space field, the spacecraft 1200 equipped with such a propulsion system can use the high thrust configuration (configuration a)) for some maneuvers, such as for example the orbit circularization maneuver, and the lower, yet more frequent, thrust configuration (configuration b)), for other maneuvers, such as, for example, maneuvers in “disturbed” environments (planets with an atmosphere for promoting aerocapture, gravitational acceleration in proximity of dissymmetrical planets, etc.).

### Claimed Invention Works

The first thought is to think that the claimed device is operating as an isolated system in space and therefore that the theorem of conservation of momentum is applicable and hence it cannot work. The basic reason why such reasoning is incorrect is because the claimed system itself is made of non-isolated parts in which there is dissipation. This completely makes the claimed system out of the conditions for application of the theorem of the conservation of momentum, as detailed herein.

The applicant shall refer to a video taken in the International Space Station (ISS) and from it the applicant shall elaborate a physical model which shall prove, experimentally or almost, that the theorem can be violated under certain circumstances.

There are two theorems at stake: one for translation and the other for rotation. The applicant reproduces the theorem of the conservation of momentum and the theorem of the conservation of the angular momentum, which is well known to one of ordinary skill in the art. The following description is taken from the document written by José-Philippe Pérez Mécanique: fondements et applications, Dunod, 2001, which is a French standard.

### Theorem of the Conservation of Momentum

Let's assume a deformable system S_{d} is composed of N moving material points with respect to a Galilean frame of reference [symbol] . Let's consider one of them Aᵢ. It is subject to the force Fᵢ exerted by all the other points of S_{d} and by bodies outside S_{d}. This force is the sum of two contributions:
1. An external strength F_{ex→i}; and
2. An inner force due to all the other material points constituting

$${S}_{d} , {\sum }_{j \neq i} {F}_{j \to i} .$$

The fundamental principle of dynamics is applied:

$$\frac{{dp}_{i}}{dt} = {F}_{ex \to i} + {\sum }_{j \neq i} {F}_{j \to i} .$$

If the whole system S_{d} is considered, we have

$$P = {\sum }_{i} {p}_{i} .$$

And so

$$\frac{d P}{d t} = {\sum }_{i} \frac{d {p}_{i}}{d t} = {\sum }_{i} {F}_{ex \to i} + {\sum }_{i} {\sum }_{j \neq i} {F}_{j \to i} = {S}_{e x} + {S}_{in} .$$

Now, the sum

$${\sum }_{i} {\sum }_{j \neq i} {F}_{j \to i}$$

is zero by virtue of Newton's third law, better known as the principle of action and reaction. Indeed F_{j→i}=F_{i→j} and therefore Sᵢₙ=0. We thus deduce the theorem of the conservation of momentum, which states that

$$\frac{d P}{d t} = {S}_{e x} .$$

### Theorem of the Conservation of Angular Momentum

Similar demonstration is provided herein for the angular momentum conservation theorem. Let's assume a system composed of material points Aᵢ. The angular momentum theorem is applied to each point:

$$\frac{d {L}_{O , i}}{d t} = {\sum }_{i} {OA}_{i} \times {F}_{ex \to i} + {OA}_{i} \times {\sum }_{j \neq i} {F}_{j \to i} .$$

Summing up on all points i, it comes:

$${\sum }_{i} \frac{d {L}_{O , i}}{d t} = \sum {OA}_{i} \times {F}_{ex \to i} + \sum {OA}_{i} \times {\sum }_{j \neq i} {F}_{j \to i} ,$$

which is interpreted as

$$\frac{d {L}_{O}}{d t} = {M}_{O , ex} + {M}_{O , in} .$$

Where

$${L}_{O} = {\sum }_{i} {L}_{O , i} {M}_{o , ex} = {\sum }_{i} {OA}_{i} \times {F}_{ex \to i} {M}_{O , in} = {\sum }_{i} {OA}_{i} \times {\sum }_{j \neq i} {F}_{j \to i} .$$

And designate respectively the total angular momentum of the system, the sum of the moments of the external forces and the sum of the moments of the internal forces. Due to Newton's third law (principle of action and reaction), we obtain:

$${M}_{O , in} = {\sum }_{i} {OA}_{i} \times {F}_{j \to i} = {\sum }_{couple ( i , j )} {OA}_{i} \times {F}_{j \to i} + O {A}_{j} \times {F}_{i \to j} = {\sum }_{couple ( i , j )} ( {OA}_{i} - {OA}_{j} ) \times {F}_{j \to i}$$

Because F_{i→j}=−F_{j→i}. Since the interaction force is carried by the vector AⱼAᵢ=OAᵢ−OAⱼ, the different vector products of the sum are zero and therefore

M_{O,in}=0

We then deduce the theorem of the conservation of angular momentum, which says that

$$\frac{d {L}_{O}}{d t} = {M}_{O , ex} .$$

The main reason why the applicant obtains these conservation theorems is that material points are used and cannot dissipate any energy. The applicant wants to emphasize the fact that material points are a view of the mind.

The applicant wishes to insist on the fact that the material point cannot exist, and the details of the calculations set forth herein are available in Jean-François GENESTE's (the inventor) recently published article entitled “Calculation of the electron radius via the assumed coherence of physics,” and the article can be downloaded from the ResearchGate website (www.researchgate.net/publication/390095928_Calculation_of_the_electron_radius_v ia_the_assumed_coherence_of_physics).

Putting ourselves in the realm of Newton's law of gravitation, which is inversely proportional to the square of the distance between two bodies. If two material points as those described herein relating to the discussion of the conservation theorem of momentum are considered, we show that, if these two material points are let go from anywhere, they will collide with infinite speed and therefore infinite kinetic energy, which is both unacceptable and never happens.

Now, both conservation theorems discussed herein are about systems made of material points. Therefore, we can conclude that there might be circumstances in which it would not work. We just need to deeply think about it because one can mistakenly equate the claimed propulsion system to a reaction wheel, equipment that is well known for not being able to propel a satellite.

Identifying the claimed propulsion system as a reaction wheel directly asserts that net rotational momentum is created by it. Initially, at the time of its firing, the propeller 201 is at rest, it should therefore, according to the conservation of angular momentum, as described and demonstrated herein, be compensated by a contrary rotation of equivalent angular momentum of the air. However, this is very unlikely, given the mass differences that are at stake. The mass of air, even at 100 bars, is much lower than the mass of one of the propeller 201.

In the claimed system, the propeller 201 does not rely on anything to rotate and that, in a perfect theoretical device, that is to say without solid friction, it will not transmit to the longitudinal tube in which it is located, any force that would lead to a counter-rotation.

Thus, characterizing the claimed propulsion system as a “reaction wheel” denies the effect in the translational field that is based on the same physics, more or less, the same theorem as for rotations.

### Experimental Proof

Let's start by referring to Astronaut Garett Reisman who posted a video on YouTube at the following address: www.youtube.com/watch?v=gp69ILqm9xs. It was posted on Aug. 29, 2025. It lasts only 40 seconds. This experiment is an official one carried out in the International Space Station (ISS) which contradicts the common perception that one can realize rotations while translation would not be possible. Given the proofs of the theorems described and demonstrated herein, this cannot be the case. Hence, if one can rotate, with a clever process, one can translate. This is the goal of the applicant's claimed invention and described in the instant patent application.

Let's describe what Astronaut Reisman shows in the ISS. An astronaut is placed immobile in the center of the ISS. He floats as the astronauts do in absence of gravity. He tries to run, but cannot move in translation, like asserted by the theorem of conservation of momentum in an isolated system.

However, at about 10 seconds into the video, he rotates once by an angle of 90°, at 11 seconds, he rotates again in the same direction again with 90°.

This is surprising, since the theorem of conservation of angular momentum says the contrary! But this is a fact! The astronaut rotates!

This means that the conditions of the theorem of the conservation of angular momentum discussed herein are not met! And this also proves that it is possible not to meet these conditions.

From this, we can easily elaborate a theoretical model which cannot be contested and will prove that motion in translation can be obtained.

Indeed, as seen in the video, the astronaut can rotate. This implies a non-zero speed of rotation, whatever it is.

Let's now model the astronaut with a vertical cylinder 500. Of course, the cylinder 500 can rotate at a non-zero speed on itself. Let's adjoin it, two blades 510 like the ones of a helicopter.

The spin of the astronaut (i.e., the cylinder 500) implies the rotation of the blades 510, as illustrated in FIG. 5.

Clearly, the blades 510, because there is air in the ISS, upon rotation (the arrow 520), will create a lift (the arrow 530) and the lift 530 implies a translation motion of the astronaut, violating the theorem of conservation of momentum, since, at the end of his trajectory, the astronaut will hit the wall of the ISS, giving to it a non-zero impulsion.

Putting ourselves in the realm of Newton's law of gravitation, which is inversely proportional to the square of the distance between two bodies. If we then consider two material points as those described in the conservation theorem of momentum, we show that, if we let go of these two material points from anywhere, they will collide with infinite speed and therefore infinite kinetic energy, which is both unacceptable and never happens.

We deduce from this very easily that the material point is a view of the mind and therefore, to a certain extent, that the theorems of conservation of momentum are also a view of the mind. The theorem is clearly not “universal,” so we must be careful not to apply it indiscriminately.

More precisely, and we will have the opportunity to return to this subject, the proof involves finite sums, because it considers a discrete world. Nevertheless, engineering and physics consider what is called the mechanics of continuous materials. The writing then switches to integrals instead of discrete sums. Let us take up in part the proof of the incriminated theorem. We have the following:

∫_{j≠1}F_{j→i}dxdydz

The notation is not rigorous herein because it only has a didactic purpose to point out what does not work. Of course, we have

∫_{j≠1}F_{j→i}dxdydz=∫_{(j·1)\hat{ }(j=1)}F_{j→i}dxdydz.

Under these conditions, we can no longer have, at least in the general case,

∫ᵢ∫_{j≠i}F_{j→i} dxdydz=0

In fact, as soon as i describes a set of nonzero Lebesgue measure on R³, it will.

The question that arises is therefore that of the relevance of the models concerning the types of environments studied. Since the applicant has shown above that the material point is a problem, we are therefore leaning towards a mechanical approach of continuous media that gives a potentially different result and conditions concerning theorems that no longer allow us to prove them, at least in the generality that is affirmed.

The working fluid filling the longitudinal tube 100 in the claimed device plays an important role in rotating the propeller 201, as explained herein.

There are two theoretical approaches for fluids: 1) the kinetic theory of gases, and 2) fluid mechanics.

What distinguishes them is always the same thing: a discrete approach in the first case with material points that are constantly subjected to elastic shocks and a continuous approach that considers a kind of UFO called a fluid molecule which is a “macroscopic” object, but whose dimensions are unknown, except that we can use the theory of integration.

Let us say a word about the latter. If we place ourselves in non-standard analysis, which is a sub-part of the Zermelo-Fraenkel theory, we introduce “true” infinitesimals to integrate, and which are much smaller than the assumed or real size of the molecules of the kinetic theory of gases. That is to say, quantities that are in one of the very many fields called hyper reals and generally denoted *R. These infinitesimals are so “small” that they are not reals, and the fields of the hyper reals are non-Archimedean. It will be noted in passing that, if we consider non-Archimedean physics, nothing happens in the same way at all and almost all convergence theorems no longer work, as we have written in some of our works on the foundations of physics.

The model of the kinetic theory of gases has a huge problem: how to show that a fluid can have a viscosity when the shocks between molecules verify the conservation of momentum and that of kinetic energy? A painful calculation shows that, when the number of molecules tends to infinity, a viscosity can be displayed. Nevertheless, in physics, which considers only a finite world, there is no infinity. And to argue that Avogadro's number should be considered as infinity would show total ignorance of set theory, which does not prevent most physicists from making this abstruse approximation.

Moving on to fluid mechanics, which leads to the famous Navier-Stokes formula.

$$ρ [ \frac{\partial v}{\partial t} + ( v \cdot grad ) v ] = - gradp + ηΔ v + ( ς + \frac{1}{3} η ) grad div v .$$

This formula is obtained in the context of an important simplification, namely that of a linearization of the phenomena locally. However, it does not lead to one, but two viscosity coefficients denoted respectively [symbol] and [symbol] , see L. D. Landau and E. M. Lifshitz, “Fluid Mechanics: Course of Theoretical Physics,” Elsevier, 2009. These coefficients have been confirmed experimentally. It should be noted that in aeronautics, both at Boeing and Airbus, they always arrange for the flow conditions to be such that

divv=0

and this is a classic trick to “forget”

[symbol]

Let's also note that, if we move away from the linear hypothesis, we could have a local development in series and therefore have an infinity of viscosity coefficients to which we would have to find a physical meaning.

The applicant therefore sees an incompatibility between the kinetic theory of gases and fluid mechanics, i.e., between a system that ensures the conservation of momentum (kinetic theory) and one that does not (fluid mechanics). Indeed, when two molecules of fluid in the sense of fluid mechanics, they can interpenetrate and viscosity then plays a role in the non-conservation of momentum. And let's notice one thing. What makes an airplane fly is viscosity! Without it, it wouldn't fly! We are therefore leaning towards fluid mechanics, and, once again, the mechanics of continuous materials, which corresponds much more to reality and with practical applications.

Therefore, because of the Navier-Stokes equations, momentum in an isolated system cannot always be conserved when fluid is involved. We will look at two examples before moving on to another point of view.

In the experiment carried by NASA, the plane has a translational motion to land and creates a vortex. If there were, in such a case, a conservation of momentum, one could not create, from an initial translational motion, an angular momentum! A picture of this can be found at the following address:
www.reddit.com/r/aviation/comments/bazirk/nasa_study_that_used_col ored_smoke_rising_from/?utm_source=copilot.com.

Similarly, there are two “barriers” on the wing of the Caravelle, an aircraft designed in 1952 by the French Company called Sud-Aviation. It is well known to all aeronautical engineers that these devices are there to “cut” the apex vortices that would otherwise twist the wing in potentially dangerous ways. Another case in which vortices do occur and are well-documented is with the Concorde. A picture of this plane can be found at the following address: www.jetphotos.com/photo/11530447?utm_source=copilot.com.

What do we get out of this? Simply that the plane flying in translation, if there was conservation of momentum, we should not have the creation of angular momentum. It will be noted, for those who would have had objections to the NASA experiment, arguing that the plane that lands has a propeller at the front that rotates and that this rotation could have caused the vortex, whereas for the Caravelle, the engines are behind the wing and can in no way disturb the forward flow.

In the vertex creation phenomenon, this is not the interaction between the wing and the air, which is the cause, but the internal friction into the air due to viscosity and we can therefore notice that there is a net creation of rotational momentum, otherwise, the vortex would not be detrimental to the wing.

For a space propulsion engine, let's turn to the Mariner 10 probe, which was the first probe in the world, designed by NASA, to benefit from gravitational assistance. There are two types of gravitational assistance: a gravitational slowdown and a gravitational acceleration. The Mariner 10 probe utilizes gravitational acceleration.

Nevertheless, if we consider, in whatever case and without taking into account the atmosphere of the planet, for example, Jupiter, the system formed by the space probe and the planet, it is a perfectly isolated system. The only force at play is the gravitational force. Now, a simple calculation shows that, in the frame of reference centered on the center of gravity of the couple (probe, planet), there must be conservation of momentum since, precisely, the system is isolated, and we can, in this very specific case with interactions at a distance, consider the two objects as material points, thanks to the theorem of Gauss. The theorem of Gauss therefore fully applies in this case. But then, if this is the case, the momentum at the output is the same as the momentum at the input. However, there is indeed acceleration! What for?

Simply because the planet revolves around the sun! The center of gravity of the couple (probe, planet) therefore has a rotational movement in the “Galilean” frame centered on the sun. When we write the equations in this last frame of reference, we see that there is no conservation of momentum, but acceleration. The same would be true and for the same reason in the case of deceleration.

In fact, the explanation hereinabove is not entirely correct. The system is not isolated, as the planet revolves around the sun through gravitation, we have a 3-body problem! And, therefore, the theorem of the conservation of momentum cannot be applied in all theory on only two bodies. In practice, however, and to make approximate and sufficient calculations, the conservation of momentum is considered in the isolated probe-planet system, and then a change of frame of reference is made to obtain the right result.

### Application to the Claimed Engine

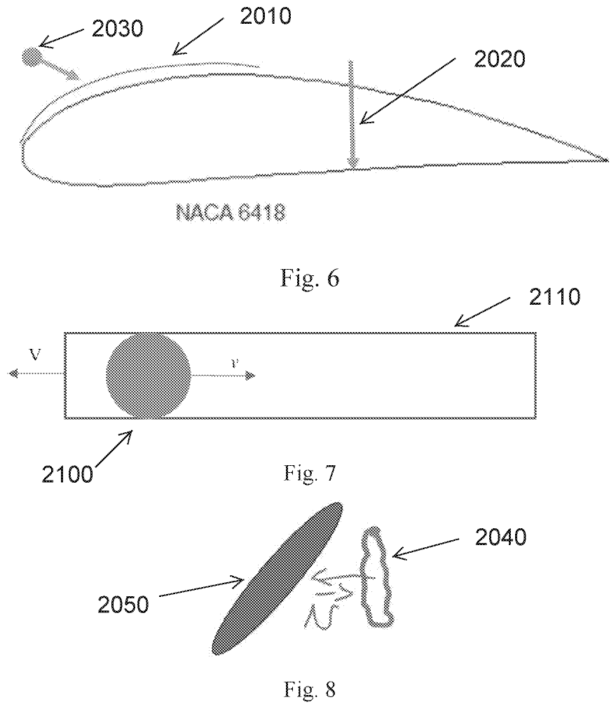

To simplify the approach, the applicant will consider a section of a propeller blade and assume that it has an asymmetrical National Advisory Committee for Aeronautics (NACA)-like profile, as shown in FIG. 6.

The aerodynamic boundary layer 2010 is related to the viscosity of the air with an air velocity on the profile that is zero and increases towards the velocity of the ambient air as one move away from the profile.

In the context of the applicant's engine and therefore this profile is running. Its speed, in FIG. 6, is therefore vertical according to the arrow 2020. This implies that the reference frame is centered at the center of gravity (“CG”) of the propeller. Some molecules 2030 will hit this boundary layer 2010 and interact with it. It will be noted that the velocity of the molecules 2030 may not be in the plane of the drawing in FIG. 6.

Regardless, we are in a similar configuration to that of the gravitational assist! Nevertheless, what interests us here is not to accelerate the molecules 2030, but to decelerate them. This happens very naturally via the interaction that has just been described herein and which slows down thanks to the viscosity of the fluid, the air in this case, and which will not allow the momentum to be preserved, especially since there is rotation, and the molecules 2030 behave, to simplify, like a space probe passing by a planet.

To ensure consistency with the explanation set forth herein, that the molecule 2030 can be considered as in the sense of the kinetic theory of gases, but the boundary layer 2010 can only emerge from fluid mechanics.

Consequently, by relating the situations of the gravitational assist and that of the claimed motor, we can irremediably conclude that there is no conservation of momentum in the collision between the molecule 2030 and the boundary layer 2010.

Since a single molecule 2030 no longer satisfies the theorem internally, the entire system cannot follow it either.

### Variation in Aerodynamic Coefficients

Considering the NACA profile shown in FIG. 6 and examined herein, and characterize it by its drag and lift coefficients which allow us to calculate the respective forces that are equal to

$$\{ \begin{matrix}D = \frac{1}{2} ρ S {C}_{x} {v}^{2} \\ L = \frac{1}{2} ρ S {C}_{z} {v}^{2}\end{matrix}$$

with standard notations. We will then experiment with two different configurations, but we will keep some quantities. In both cases, the terms Cₓ and S are the same. On the other hand, in the first experiment, the ratio is C_{z}/Cₓ=20 while in the second, it is C_{z}/Cₓ=80 a traditional value in the field of gliders. Of course, we do not necessarily consider the same profiles, and they are not necessarily of the NACA 6418 type either. What we are interested in here is to keep the same Cₓ, the same surface area S and the same masses and moments of inertia.

Let's describe what will happen succinctly. We will therefore have the same drag in both cases and therefore the same translational movement in the tube with permanent deceleration until it stops. On the other hand, the lift coefficients being substantially different, the angular momentum will also be different.

The mass and moment of inertia of the propellers are assumed to be the same. We are therefore faced with a somewhat dire problem. Indeed, we have, at an unspecified time, total energy of the propeller with a high lift coefficient higher than that which has a lower one. Deducing this is very simple, since the two propellers go at the same speed of translation, but do not have the same speed of rotation. Note that the pressure field slowing down the tube is the same in both cases thanks to having the same drag. However, the initial impulse is the same. So, we see that there is a contradiction. If, in addition, we consider the cylinder in the overall equation of the system, this allows us to eliminate the paradox. That is, there must be a residual speed in space of the cylinder.

### Soft Shock in an Empty Tube

Consider a tube 2110 in which there is a vacuum and into which a ball 2100 is fired which will bounce off the wall at the bottom of the tube 2110, as shown in FIG. 7, losing kinetic energy with each bounce. Let's break down the calculations for a ping-pong ball 2100 in a vacuum tube 2110.

Preserving the initial moment when throwing the ball results in

MV=mv

where m is the mass of the bullet and M that of the cylinder. Let's call l the length of the cylinder and assume that in a shock, the ball bounces only with one factor 1/n of its initial relative kinetic energy. FIG. 7 implies that the relative kinetic energy of the ball with respect to the bottom of the cylinder is

$$\frac{1}{2} {m ( v + V )}^{2} .$$

It will therefore bounce back with a relative kinetic energy that will be

$$\frac{1}{2 n} {m ( v + V )}^{2} .$$

Moreover, during the impact there is conservation of momentum. So, if the velocity of the bullet after the impact is v₁ and if that of the cylinder is V₁, we will have

mv₁=MV₁

We notice, at the very least, that the velocities, in absolute reference, must have different directions, otherwise we would no longer have the nullity of the total momentum. Also, as the ping-pong ball 2100 bounces, it's clear that it's going to have a non-zero speed to the left. We have either

$$\frac{1}{2} m {v}_{1}^{2} = \frac{1}{2 n} {m ( v + V )}^{2}$$

$$or$$

$${v}_{1} = \frac{1}{\sqrt{n}} ( v + V ) ,$$

$$so$$

$${V}_{1} = \frac{m}{M} \frac{1}{\sqrt{n}} ( v + V ) .$$

so

It can therefore be seen that despite the conservation of momentum during the impact, the rebound velocity in the tube, in modulus, decreased from a certain value of Vn. This last point is important, and we will have to remember it later.

### Collision of a Fluid Molecule and a Solid

This is a case where a fluid molecule in the sense of fluid mechanics collides with a sharp, solid surface, as shown in FIG. 8. The fluid solid collision can be summarized as follows.

The relative velocity of the fluid molecule 2040 is v, as shown in FIG. 8. In a frame of reference centered on the solid 2050, which is immobile. Now, upon contact, the fluid molecule 2005 will deform gradually.

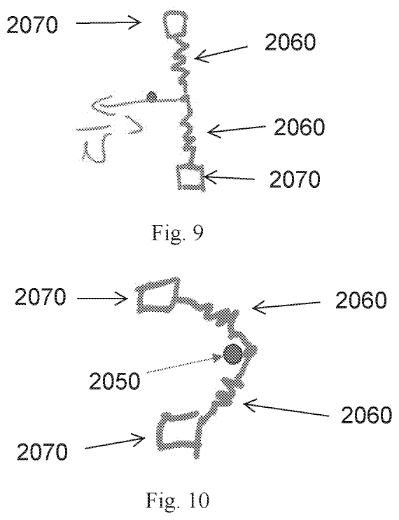

This problem can be reasonably approached where we represent a cross-section, as exemplary shown in FIG. 9. The fluid molecule 2040 can therefore be modeled by two connected springs 2060 that are articulated and connected to two weights 2070 represented by the squares.

Let's look at what happens at a particular moment in the collision, as exemplary shown in FIG. 10. At the moment of impact, no mass is at stake given the point of impact we have chosen on the fluid molecule 2040 (FIGS. 9 and 10). The momentum felt at this very particular moment is therefore zero, since the mass at play (in the middle of the two springs 2060) is zero! The principle of action and reaction therefore gives a zero-force applied to the solid.

However, as the device is deformed, the mass of the weights 2070 comes into play. There is therefore, in the chosen coordinate system, a momentum of the springs 2060 and the weights 2070, while the solid 2050 does not move. In addition, the forces exerted by the weights 2070 on the springs 2060 will vary as the angle between the two parts of the fluid molecule 2040 will make a smaller angle between them. In addition, to have a correct model that represents the viscosity of the fluid, the springs 2060 must be dissipative and isotropic. To be more correct, we would therefore have to consider spheres composed of infinitesimal springs uniformly distributed over the sphere. But let's stay in the approximation of FIGS. 9 and 10, which will suffice. The applicant notes that with the dissipations that occur continuously and therefore at each instant, part of the initial momentum is lost in the dissipation provided by the springs 2060, which guarantees that in the end, during the shock, the initial momentum that arrived on the solid 2050, will not be the one seen in the end for the application of Newton's third law. It will be less, because the deformation of the fluid molecule 2040 will have consumed part of this momentum via soft shocks between chemical molecules (and no longer fluid this time), which is not considered by the kinetic theory of gases, but by fluid mechanics and which remains an unsurpassable reality to this day.

The theorems of the conservation of momentum, based on material points, can in no way deal with the dissipative deformations of bodies during collisions. Therefore, mathematical formalism imposes absolute respect for Newton's third law. But the applicant has just shown here that when dealing with deformable bodies, moreover with internal losses, the shocks or contacts no longer necessarily last for negligible times and see variable forces in which, locally and at each moment, Newton's third law applies, but over the entire duration. There are losses, because the object arriving in collision itself consumes, in the impact, a part of its momentum. This is what is done in the automotive sector with a non-deformable interior, but a shock absorption by, say, the front of the vehicle that will limit the acceleration felt by the passenger.

The claimed invention, having been described, will make it apparent to those skilled in the art that the same may be varied in many ways without departing from the spirit and scope of the invention. Any and all such modifications are intended to be included within the scope of the claimed invention.

1. A space propulsion system comprising:
a motor comprising a pair of parallel longitudinal tubes, each longitudinal tube comprising:
a first end and a second end, and defining an internal sealed volume filled with a working fluid;
a projectile positioned within the internal sealed volume and constrained move solely in a longitudinal direction, the projectile being rigidly and non-rotatably coupled to a propeller such that translation of the projectile produces rotation of the propeller with no relative motion between them;
a projectile launcher positioned at the first end and configured to impart a controlled translational acceleration to the projectile within the internal sealed volume, the propeller being arranged such that a translational movement of the projectile is mechanically converted into a rotational movement of the propeller to generate thrust;
a rotational brake, arranged at the second end, configured to decelerate and arrest rotation of the projectile and the propeller as the projectile reaches the second end;
a projectile return mechanism configured to return the projectile from the second end to the first end without uncoupling the projectile from the propeller;
a heat dissipator thermally coupled to at least one of said each longitudinal tube, the projectile launcher or the rotational brake to manage thermal energy generated by repeated projectile cycles; and
at least one power source operatively connected to the projectile launcher and the projectile return mechanism; and
wherein the propellers in the pair of parallel longitudinal tubes rotate in opposite directions, thereby providing contrarotating propulsion output that reduces a net torque on the propulsion system.

2. The propulsion system of claim 1, wherein said each longitudinal tube of the pair of parallel longitudinal tubes comprises a projectile holder to hold the projectile in the internal seal volume.

3. The propulsion system of claim 2 wherein the projectile holder comprises at least one connecting arm extending between the projectile and said each longitudinal tube.

4. The propulsion system of claim 2, wherein the projectile holder and the projectile are connected by a pivot connection.

5. The propulsion system of claim 1, wherein said each longitudinal tube comprises a translational guide to guide the projectile in translation in the internal sealed volume.

6. The propulsion system of claim 5, wherein said each longitudinal tube comprises a projectile holder to hold the projectile in the internal volume; and wherein the translational guide cooperates with the holder.

7. The propulsion system of claim 1, comprising a tilter configured to independently pivot each longitudinal tube of the pair of parallel longitudinal tubes about a respective parallel pivot axis.

8. The propulsion system of claim 1, further comprising a plurality of pairs of parallel longitudinal tubes arranged parallel to one another.

9. A spacecraft comprising a propulsion system of claim 1.

10. The propulsion system of claim 1, wherein the rotational brake is an electromagnetic brake.

11. The propulsion system of claim 1, wherein the rotational brake is a mechanical brake.

12. The propulsion system of claim 1, wherein the projectile return mechanism is a worm screw.
